(19) United States
(12) Patent Application Publication
(10) Pub. No.: US 2006/0205271 A1
(43) Pub. Date: Sep. 14, 2006

(54) Electric connector fixation device

(75) Inventor: Cheng-Chung Hsu, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/080,890

(22) Filed: Mar. 11, 2005

(51) Int. Cl. H01R 13/73

(52) U.S. Cl. 439/573

(57) ABSTRACT

An electrical connector fixation device having at least a connector housing and a fastening piece is proposed. The connector housing has at least a receiving portion for accommodating the electrical connector and a compressing board portion to deform the receiving portion by compression. The fastening piece is used to hold the compressing board portion and to fix the connector housing on a body of electrical device. With such design, an electrical connector is assembled in the body of electric device, so that the body of electric device is expanded with device interconnection function.

### BACKGROUND OF THE INVENTION

1) Field of the Invention

This invention relates to an electrical product assembly technology, in particular, to an electrical connector fixation device applicable to an electrical connector, such as a Universal Serial Bus-type (USB-type) connector, a FireWire-type connector, an Ethernet-type connector, or a phone line-type connector, assembled in a body of an electrical device, which, for example, can be a USB-type peripheral storage device.

2) Description of the Prior Art

A majority of personal computer (PC) platforms are usually equipped with a plug-and-play type of external communication interface, such as a USB-type or a FireWire-type communication interface, so that a computer peripheral, such as an external (removable) micro drive, a pocket drive (i.e., a removable flash memory drive), a printer or a digital camera, and so on can be connected to the PC platform via the external communication interface. As the USB-type or FireWire-type communication interface is equipped with plug-and-play function, such plug-and-play communication interface has become a necessary external communication interface for the majority of PC platforms.

A current assembly of the USB-type electrical connector and the body of electrical device is an external plug-in design outside the body of the electrical device. That is, the design is merely applicable to connecting the USB-type connector outside the body of the electrical device. In view of the design of the USB-type storage device, the USB-type connector is often needed to assemble inside the body of the electrical device to expand device interconnection of the USB-type storage device. Therefore, there is a growing demand in the industry for an assembled structure applicable to assemble the USB-type connector in the body of electrical device.

### SUMMARY OF THE INVENTION

In view of the drawbacks associated with the prior art, an objective of the invention is to provide an electrical connector fixation device that can assemble an electrical connector in a body of an electric device.

The electrical connector fixation device is designed to assemble the electrical connector, such as a USB-type connector, a FireWire-type connector, an Ethernet-type connector, or a phone line-type connector, inside the body of the electrical device, wherein the electrical device can be a USB-type peripheral storage device.

To achieve the aforementioned and other objectives, the invention provides an electrical connector fixation device for assembling at least an electrical connector in the body of the electrical device. The electrical connector fixation device comprises a connector housing, which is mounted inside the body of the electrical device and contains at least a receiving portion for accommodating the electrical connector, and a compressing portion, which clamps the electrical connector by compressive deforming the receiving portion, and a fastening piece, which is used to fix the connector housing on the body of the electrical device and to hold the compressing board portion.

The above-mentioned fastening piece comprises a first attachment piece, which is fixed on the body of the electrical device, and a second attachment piece that can be engaged with the first attachment piece. The first and second attachment pieces respectively have first thread and second thread to engage with each other. For example, the first thread can be an inner thread and the second thread can be an outer thread. Alternatively, the first thread can be the outer thread and the second thread can be the inner thread. Preferably, the first attachment piece can be a stud having inner thread formed on a top end thereof, and the second attachment piece can be a bolt. Also, the first attachment piece can be a bolt and the second attachment piece can be a nut.

The bottom end of the connector housing further comprises a protruded leg portion, and the device body is formed with a positioning portion for engaging with the protruded leg portion, thereby the connector housing is prevented from coming off from the body of the electrical device when the connector housing is subjected to a rotational torque.

While the fastening piece is designed as an engagement of the first and second attachment pieces, the fastening piece may also be an elastic structure, which elastically recoils after being compressed, so as to cap on connector housing for fastening.

Moreover, the connector housing further comprises a receiving portion that is formed on a side of the compressing board portion for accommodating the fastening piece. Preferably, the receiving portion may vary according to different fastening piece designs. For example, the receiving portion can be divided into a first receiving portion for containing the first attachment piece and a second receiving portion for containing the second attachment piece. In the above-mentioned example, the receiving portion can be divided into receiving portions for containing a stud and a bolt, or receiving portions for containing a bolt and a nut.

Moreover, the electrical connector can be either one of a USB-type connector, a FireWire-type connector, an Ethernet-type connector, or a phone line-type connector. Preferably, the electrical device is a USB-type storage device. The electric connector fixation device is characterized by assembling an electric connector in the body of electric device, so that the body of the electrical device is expanded with device interconnection to improve its utility and applicability.

### BRIEF DESCRIPTION OF THE DRAWINGS

FIG. 1 is a perspective, exploded view showing an electrical connector fixation device as well as associated electrical connector and body of electrical device before being assembled in one integral body according to the invention;

FIG. 2 is a cross-sectional view showing a cross-sectional profile of the electrical connector fixation device and the device body according to the invention;

FIGS. 3A and 3B are perspective views showing a method of plugging the electrical connector into the connector housing of the electrical connector fixation device according to the invention;

FIG. 4 is a perspective view showing a structure after the electrical connector fixation device as well as associated electrical connector and body of electrical device are assembled in one integral body according to the invention;

FIG. 5 is a cross-sectional diagram showing a cross-sectional structure after the electrical connector fixation device as well as associated electrical connector and body of electrical device are assembled in one integral body according to the invention;

FIG. 6 is a cross-sectional diagram showing the cross-sectional profile of the electrical connector fixation device and the associated device body according to another embodiment of the invention; and

FIGS. 7A and 7B are cross-sectional diagrams showing operations of the electrical connector fixation device, the associated electrical connector and device body when assembled in one integral body according to the invention.

### DETAILED DESCRIPTION OF THE PREFERRED EMBODIMENTS

To enable a further understanding of the structural features and the technical contents of the invention, the brief description of the drawings below is followed by the detailed description of embodiments.

FIG. 1 is a perspective, exploded view showing each of the components in the electric connector fixation device, and an electric connector 10 and body of electrical device (or a device body) 20 associated with the electric connector fixation device before being assembled into one integral body according to the invention. Practically, the electrical connector fixation device serves to assemble the electrical connector 10 in the device body 20, wherein the electrical connector 10 can be a USB-type connector, a FireWire-type connector, an Ethernet-type connector, or a phone line-type connector. And the device body 20 belongs to the electrical device such as a USB-type storage device, a desktop PC, a notebook computer, or a network server, and so on.

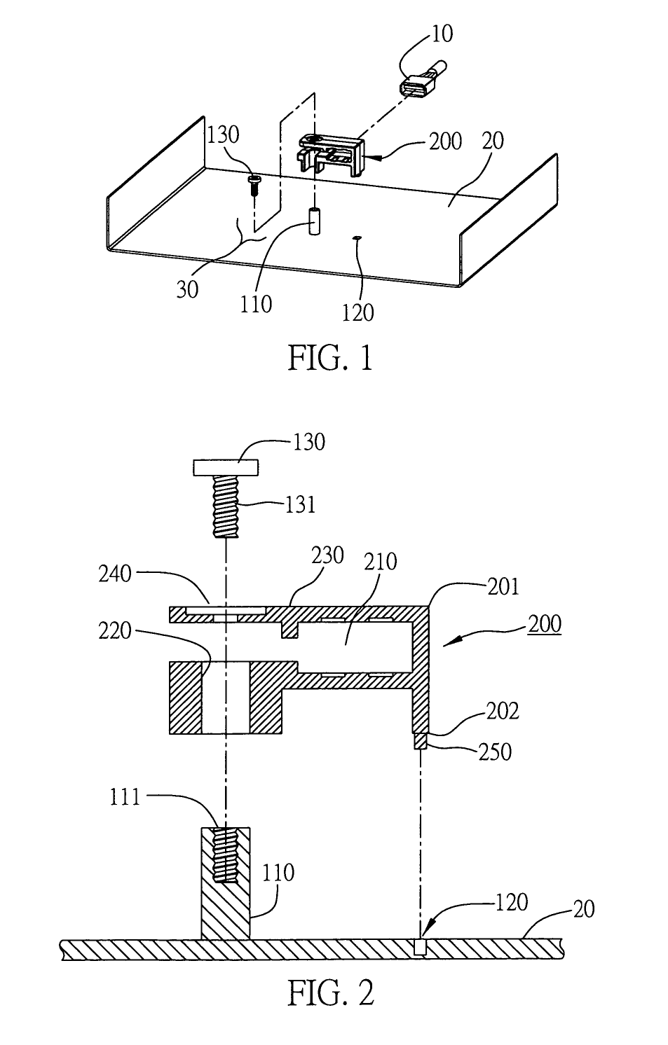

As shown in FIGS. 1 and 2, the electrical connector fixation device comprises at least a connector housing 200 and a fastening piece 30 for fixing the connector housing 200 in the device body 20. The fastening piece 30 comprises a first attachment piece and a second attachment piece that matches with the first attachment, thereby enabling the electrical connector 10 to be fixed on the connector housing 200 when the first attachment piece is engaged with the second attachment piece. The connector housing 200 is then mounted on the device body 20.

The first attachment piece is embodied as a stud 110 having a first thread 111, such as an inner thread (the first thread 111 may also be an outer thread in other embodiments) formed on a top end of the stud 110, while a bottom end of the stud 110 is fixed at a first predetermined position on the device body 20. Practically, the first predetermined position may be a specific position inside the device body 20 (i.e., the position preserved for positioning the electrical connector 10).

The device body 20 forms a positioning portion 120, such as a groove or a through hole at a second predetermined position. And the positioning portion 120 is adjacent to the location of the stud 110 (i.e., the position preserved for installing the electrical connector 10).

The second attachment piece is embodied as a bolt 130, which comprises a second thread 131 such as an outer thread whose size and specification fits perfectly with the first thread 111 of the stud 110, thereby the second thread 131 of the bolt 130 is screwed into the first thread 111 of the stud 110. If the stud 110 has the outer thread instead, the bolt 130 should be designed as having the corresponding inner thread.

The connector housing 200 is formed as an integral structure having a top end 201 and a bottom end 202, and is at least divided into five structural portions, including (d1) a receiving portion 210 for accommodating the electrical connector, (d2) a receiving portion 220 for accommodating the stud, (d3) a compressing board portion 230, (d4) a recess 240 for holding the bolt, and (d5) a protruded leg portion 250.

The receiving portion 210 is open through from the front surface to the back surface and is formed between the top end 201 and the bottom end 202 of the connector housing 200. The accommodating space of receiving portion 210 approximately matches the volume of the electrical connector 10 so as to accommodate the electrical connector 10 therein.

The receiving portion 220 is formed on a lateral side of the receiving portion 210 to vertically extend from the top end 201 toward the bottom end 202. The accommodating space of the receiving portion 220 approximately matched the diameter of the stud 110, so as to accommodate the stud 110 therein.

The compressing board portion 230 is formed on the top end 201 of the connector housing 200 and is adjacent to upper parts of the receiving portions 210 and 220. When the compressing board portion 230 is pressed down by pressure, the receiving portion 210 is slightly deformed to diminish.

The recess 240 is formed in the compressing board portion 230 of the connector housing 200 and is located right on top of the receiving portion 220. And an inner diameter of the recess 240 is designed to match an outer diameter of the bolt 130, so that the bolt 130 can pass through and engage with the recess 240.

The protruded leg portion 250 is formed on the bottom end 202 of the connector housing 200. And the size of the protruded leg portion 250 would match to the positioning portion 120, in order to engage the protruded leg portion 250 with the positioning portion 120.

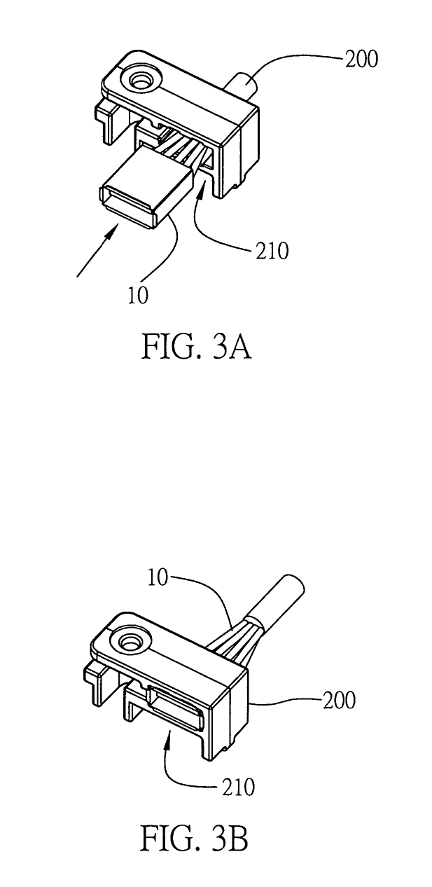

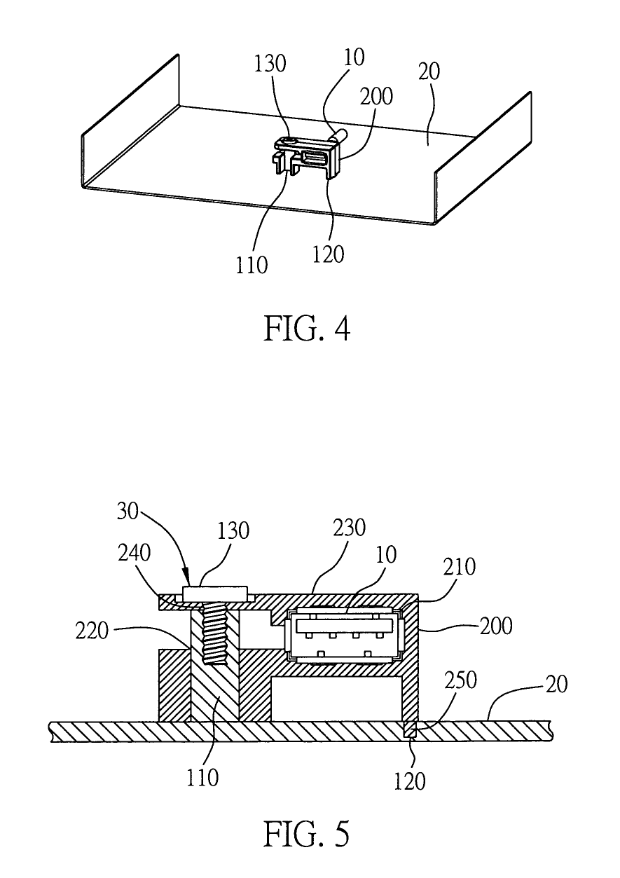

In an actual assembly operation, the stud 110 is fixed to a predetermined location inside the device body 20, by either integrally formed with the electric device body 20, or fixed to the device body 20 through a bolt. Subsequently, when the electrical connector 10 is assembled to the device body 20, as shown in FIG. 3A, the electrical connector 10 is inserted from the front surface into the receiving portion 210 of the connector housing 200 (positioning of the electric connector after insertion is shown in FIG. 3B). As shown in both FIGS. 4 and 5, the receiving portion 220 of the connector housing 200 is aligned with the stud 110 on the device body 20 so as to accommodate the stud 110 within the receiving portion 220. Meanwhile, the protruded leg portion 250 is aligned with the positioning portion 120 on the device body 20 to enable engagement of the protruded leg portion 250 with the positioning portion 120, so that the connector housing 200 is mounted on the device body 20.

After the connector housing 200 is mounted and positioned on the device body 20, the second thread 131 of the bolt 130 pass through the recess 240 on the compressing board portion 230 of the connector housing 200 and engage with the first thread 111 of the stud 110, thereby enabling the connector housing 200 to be fixed on the device body 20. As the bolt 130 is tightly screwed, a downward pressure applied to the compressing board portion 230 for tightly pressing against the electrical connector 10. Therefore, the receiving portion 210 is slightly deformed to diminish, so as to clamp the electric connector 10 in the connector housing 200. Accordingly, the assembly of the electric connector 10 and the device body 20 is completed.

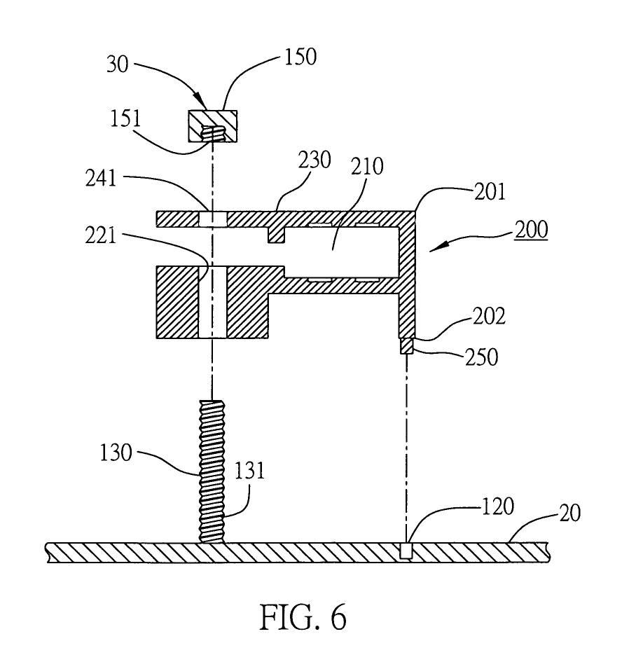

FIG. 6 illustrates another embodiment showing the first attachment piece and the second attachment piece of the fastening piece 30. The first attachment piece is embodied as a bolt 130, having a second thread 111, such as an outer thread on one end and the other end of bolt 130 is fixed on a first predetermined position on the device body 20. The second attachment is embodied as a nut 150, having a first thread 151, such as an outer thread. In addition, the size and specification of the first thread 151 is designed to match with the second thread 131 of the bolt 130, thereby the first thread 151 of the nut 150 can be engaged with the second thread 131 of the bolt 130. Moreover, a positioning portion 120 is formed at a second predetermined position of the device body 20, and the second predetermined position is adjacent to the location of the bolt 130 (i.e., the position for mounting the electrical connector 10). In addition, in order to correspond to the fastening piece 30, the connector housing 200 is embodied as an integral component having a top end 201 and a bottom end 202. And the connector housing 200 is divided into at least five portions, including (d1) a receiving portion 210 for accommodating the electrical connector, (d2) a recess 221 for holding a first bolt, (d3) a compressing board portion 230, (d4) a recess 241 for holding a second bolt, and (d5) a protruded leg portion 250. The five portions are respectively described as follows.

The receiving portion 210 is open through from the front surface to the back surface and is formed between the top end 201 and the bottom end 202 of the connector housing 200. The accommodating space of receiving portion 210 approximately matches with the volume of the electrical connector 10 so as to accommodate the electrical connector 10 therein.

The receiving portion 221 is formed on a lateral side of the receiving portion 210 to vertically extend from the top end 201 toward the bottom end 202. The accommodating space of the receiving portion 221 approximately matched the diameter of the bolt 113, so as to accommodate the bolt 113 therein.

The compressing board portion 230 is formed on the top end 201 of the connector housing 200 and is adjacent to upper parts of the receiving portions 210 and 221. When the compressing board portion 230 is pressed down by pressure, the receiving portion 210 is slightly deformed to diminish.

The recess 241 is formed in the compressing board portion 230 of the connector housing 200 and is located right on top of the receiving portion 221. And an inner diameter of the recess 241 is designed to match with an outer diameter of the bolt 130, so that the bolt 130 can pass through and engage with the recess 241.

The protruded leg portion 250 is formed on the bottom end 202 of the connector housing 200. And the size of the protruded leg portion 250 would match to the positioning portion 120, in order to engage the protruded leg portion 250 with the positioning portion 120.

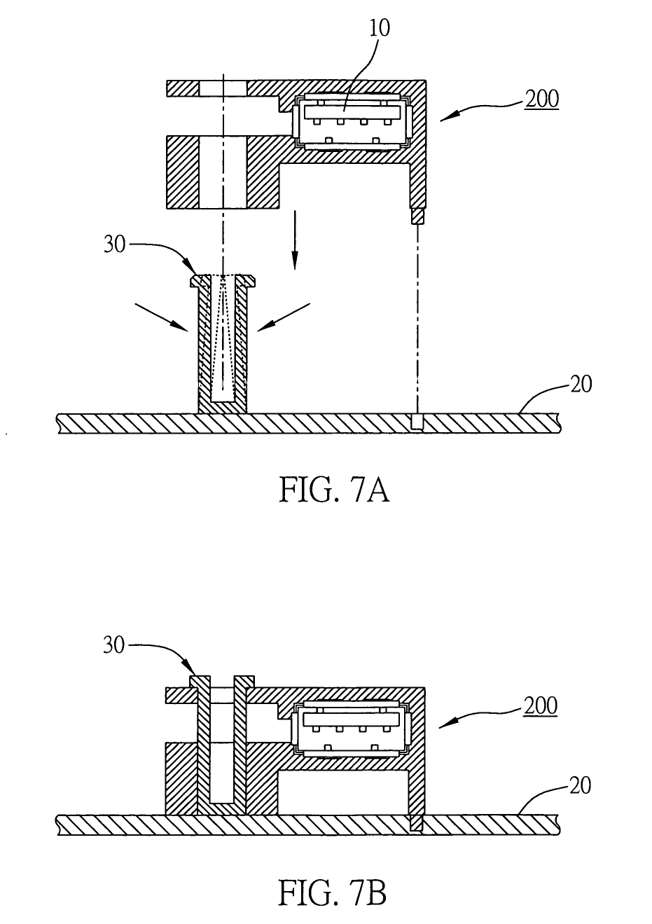

In addition, as shown in FIGS. 7A and 7B, the fastening piece 30 can be embodied as an elastic structure, which possesses the characteristic of recoiling after being compressed and is capped on the housing 200 and fastened thereto. Since the correspondent structures related to the connector housing 200 and the device body 20 are identical in design illustrated in FIG. 6, the detailed description thereof is omitted herein.

Summarizing from the above, the present invention provides an electrical connector fixation device, which is adapted to assemble an electrical connector 10 in the body 20 of the electrical device, and the invention is characterized in that the electric connector 10 can be assembled in the body 20 of the electrical device. Thus, the body 20 of the electric device is expanded with device interconnection to improve its utility and applicability.

It is understood that the disclosed embodiments are merely exemplary of the invention that may be embodied in various forms. The substance of the invention is broadly defined as claimed below. In the event any technical embodiments or methods completed by those skilled in the art are found completely identical to the definitions as claimed below, or can be regarded as an equivalent substitution, such embodiments or methods are regarded as within the intended scope of the invention.

What is claimed is:

1. An electrical connector fixation device for fixing at least an electrical connector inside a device body, the electrical connector fixation device comprising:
a connector housing mounted on the device body, the connector housing having at least a receiving portion for accommodating the electrical connector and a compressing board portion for deforming the receiving portion by compression, so that the electrical connector is clamped; and
a fastening piece for fixing the connector housing on the device body and holding the compressing board portion.

2. The electrical connector fixation device of claim 1, wherein the fastening portion comprises a first attachment piece fixed on the device body and a second attachment piece engaged with the first attachment piece.

3. The electrical connector fixation device of claim 2, wherein the first attachment piece and the second attachment include a first thread and a second thread to engage with each other.

4. The electrical connector fixation device of claim 3, wherein the first thread is an inner thread and the second thread is an outer thread.

5. The electrical connector fixation device of claim 3, wherein the first thread is the outer thread and the second thread is the inner thread.

6. The electrical connector fixation device of claim 2, wherein the first attachment piece is a stud having the inner thread on a top end thereof and the second attachment piece is a bolt.

7. The electrical connector fixation device of claim 2, wherein the first attachment piece is a bolt and the second attachment piece is a nut.

8. The electrical connector fixation device of claim 1, wherein a bottom end of the connector housing further comprises a protruded leg portion, and the device body is formed with a positioning portion for engaging with the protruded leg portion.

9. The electrical connector fixation device of claim 1, wherein the fastening piece is an elastic structure that recoils after being compressed and is capped on the connector housing for fastening.

10. The electrical connector fixation device of claim 1, wherein the connector housing further comprises a receiving portion for insertion of the fastening piece, and the receiving portion is formed on a side of the compressing board portion.

11. The electrical connector fixation device of claim 1, wherein the electrical connector is a USB-type connector.

12. The electrical connector fixation device of claim 1, wherein the electrical connector is a FireWire-type connector.

13. The electrical connector fixation device of claim 1, wherein the electrical connector is an Ethernet-type connector.

14. The electrical connector fixation device of claim 1, wherein the electrical connector is a phone line-type connector.

15. The electrical connector fixation device of claim 1, wherein the electrical device body is a USB-type storage device.
